(19) United States
(12) Patent Application Publication
(10) Pub. No.: US 2024/0419305 A1
(43) Pub. Date: Dec. 19, 2024

(54) System for the Remote Creation and Delivery of Digital Portraits

(71) Applicants: Abtine Najand, Walnut Creek, CA (US); Ali Taheri, Walnut Creek, CA (US)

(72) Inventors: Abtine Najand, Walnut Creek, CA (US); Ali Taheri, Walnut Creek, CA (US)

(21) Appl. No.: 18/413,567

(22) Filed: Jan. 16, 2024

Related U.S. Application Data
(60) Provisional application No. 63/521,318, filed on Jun. 15, 2023.

(51) Int. Cl. G06F 3/0484; G06F 3/0482; G06F 3/0488; G06F 3/12; G06F 3/14; G06Q 20/34; H04N 23/63; H04N 23/66; H04N 23/695

(52) U.S. Cl. CPC G06F 3/0484; G06F 3/0482; G06F 3/0488; G06F 3/1293; G06F 3/1454; G06Q 20/34; H04N 23/631; H04N 23/66; H04N 23/695

(57) ABSTRACT

A system and method for the remote creation of digital portraits is presented. The system includes a local computing device with input devices including a touchscreen monitor, microphone, speakers, camera and fee payment device, and output devices including a printer and a pen plotter. A paper transfer subsystem transfers paper from the printer to the pen plotter. The above hardware being packaged in a cabinet styled as a photo booth. The local computing device is connected to a remote computing device equipped with a digital painting program, via a network. A user interface application (“UI”) is stored in memory on the local and remote computing devices. The UI is configured to operate the system hardware so as to allow a user of the local computing device to contact an artist using the remote computing device to have a digital portrait painted. Once the digital portrait is completed, the portrait is printed out by the local computing device.

### CROSS-REFERENCES TO RELATED APPLICATION

This application claims the benefit of U.S. Provisional Application Ser. No. 63/521,318, filed Jun. 15, 2023 and entitled “ROBOARTIST,” which is incorporated herein by this reference.

### FIELD OF THE INVENTION

The invention relates generally to the field of digital imaging and more particularly to a system which allows a user to have a portrait painted digitally by a remotely located artist and have the portrait printed or plotted at the location where the user “sat” for the portrait.

### BACKGROUND ART

Since at least the early development of painting in premodern times, it is likely that consumers have desired to have their portraits painted. In modern times, formal portraits are typically painted by an artist in a studio, which typically limits consumers desiring to have their portraits painted to only locally available artists, which are often in short supply and costly, even if available. For these reasons, photographic portraits have now largely replaced painted portraits.

However, as photography has improved to the point where virtually anyone with a modern camera, including those found on smartphones, can take an exceptional quality picture, photographic portraits have become ubiquitous and therefore less desirable than a painted portrait. An artistic painted rendering of an individual tends to have more appeal and value to customers than photographic portraits. The typical person is capable of taking a photograph but not everybody is an artist. Therefore, consumer interest in painted portraits has been rekindled in recent years.

Presently, to commission a hand painted portrait, a consumer is either limited to local artists or must travel to the artist's location, which imposes unnecessary expense. Alternatively, a consumer could pay an artist's travel expenses to the consumer's location, which is likely to be equally, if not more, costly, than traveling to the artist's location.

What is needed in the art therefore is system whereby a consumer may select from a variety of remotely located artists, commission a selected artist to paint a portrait and have the portrait provided to the consumer shortly after completion of the painting. Ideally, such a system will be packaged within a known and familiar setting such as, for example, that of a conventional photo booth, that can be readily placed in places that consumers frequent such as shopping malls and tourist venues.

### SUMMARY OF THE INVENTION

The present invention meets a long-felt need in the art by providing a system for the remote creation and delivery of digital portraits, where a consumer may review profiles of a number of remotely located artists, commission an artist to remotely paint the consumer's portrait in real-time, and, have the remotely painted portrait reproduced at the consumer's location, shortly after completion of the painting. The system may also provide other services including the purchase and printing of autographed celebrity photographs, other artwork, or artificial intelligence generated artwork.

The system and method for the remote creation and delivery of digital portraits includes a local computing device which is connected to one or more remote computing devices via a network, such as the internet. The local computing device is equipped with input devices including a touchscreen monitor, microphone, speakers, camera and a fee payment device, and, further includes output devices including a printer and a pen plotter and paper transfer subsystem for transferring paper from the printer to the pen plotter. The local computing device and above-described hardware may be packaged in a cabinet styled as a photo booth.

A user interface application (“UI”) is stored in memory on the local and remote computing devices. The UI is configured to operate the system hardware so as to allow a user of the local computing device to search a database of remotely located artists, select a particular remotely located artist, and to commission the remotely located artist to digitally paint the user's portrait. Once completed, the digital portrait is transmitted by the remote computing device to the local computing device where it is printed out for the user.

The system provides options for other services which may include selecting from a database and printing autographed celebrity photographs or other artwork. The system may further provide an option for allowing a user to select a program from a database of artificial intelligence (“AI”) artwork generation programs and use the selected AI program to create an artwork, which can then be locally printed.

The above and other advantages of the system for the remote creation and delivery of digital portraits of the present invention will be described in more detail below.

### BRIEF DESCRIPTION OF DRAWINGS

FIG. 1 is a schematic diagram of a cabinet in the style of a photobooth containing the elements of the system for the remote creation and delivery of digital portraits of the present invention.

FIG. 2 is a schematic diagram of the system of the present invention.

FIG. 3 is a schematic top view of the paper transfer subsystem of the present invention.

FIG. 4 is a schematic end view showing in part the pinch tray of the paper transfer subsystem of the present invention.

FIG. 5 is a schematic representation of a lobe which raises and lowers the pinch tray of the paper transfer subsystem of the present invention.

FIG. 6 is a schematic side view showing adjustable supports for raising or lowering the height of the paper transfer subsystem of the present invention.

FIG. 7 is an exemplary flow diagram showing the process steps of the user interface application of the present invention.

FIG. 8 is an exemplary flow diagram showing the process steps of the “Meet an Artist” option of the user interface application of the present invention.

FIG. 9 is an exemplary flow diagram showing the process steps of the “Autographs” option of the user interface application of the present invention.

FIG. 10 is an exemplary flow diagram showing the process steps of the “Buy Artwork” option of the user interface application of the present invention.

FIG. 11 is an exemplary flow diagram showing the process steps of the “AI Art Generator” option of the user interface application of the present invention.

FIGS. 12A to 12I shows an exemplary implementation of the portrait painting option of the user interface application of the present invention.

FIGS. 13A to 13G show an exemplary implementation of the autographed portraits option of the user interface application of the present invention.

FIGS. 14A to 14H show an exemplary implementation of the artwork purchase option of the user interface application of the present invention.

FIGS. 15A to 15G show an exemplary implementation of the artificial intelligence artwork generation option of the user interface application of the present invention.

FIG. 16 is an exemplary schematic diagram of the process of the artwork protection option of system of the present invention.

FIG. 17 is an exemplary flow diagram showing the process steps of the artwork protection option of system of the present invention.

FIG. 18 is an exemplary flow diagram showing the process steps of the artwork authentication option of system of the present invention.

### DETAILED DESCRIPTION OF THE PREFERRED EMBODIMENTS

The present invention will now be described more fully hereinafter with reference to the accompanying drawings, in which preferred embodiments of the invention are shown. The invention however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

The system for the remote creation and delivery of digital portraits 10 is an internet based system that uses software applications resident on computing devices or accessible by means of computing devices, to allow a user of a local computing device to select a remotely located artist to paint the user's portrait using digital painting software.

A computing device or computing device is generally defined herein as a device containing at least one processor, memory device, visual display device and text input device and an operating system capable of running software applications. Software applications are defined as instruction sets or code, storable on a memory device and executable by a processor. The meaning of the terms “computing device” and “software applications” and representative examples of such devices and applications are further discussed infra in this disclosure.

As used herein, the term “video call” shall be presumed to include chat, audio and video components of a video call over a network.

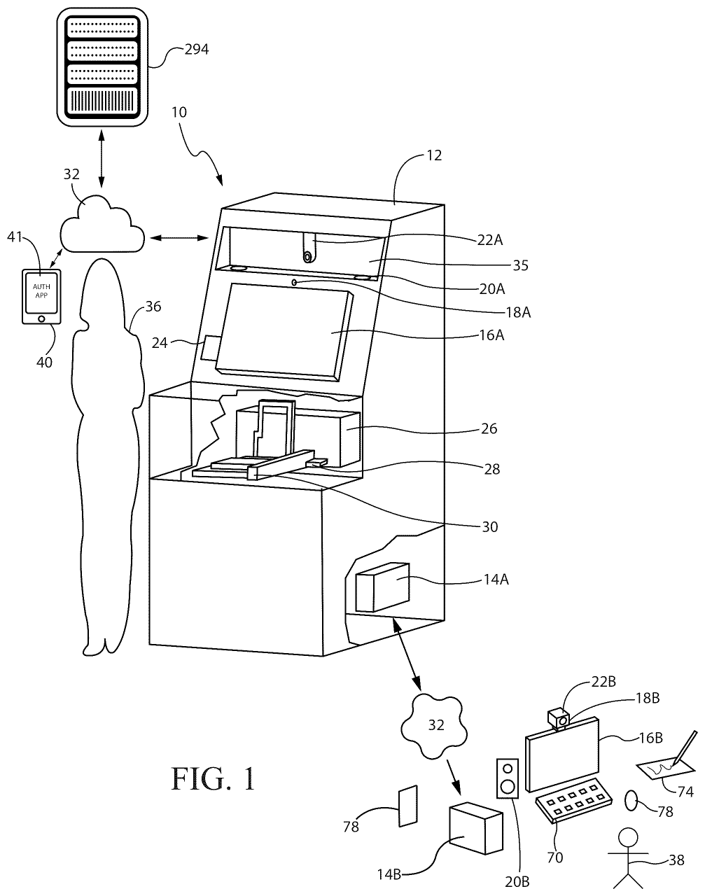

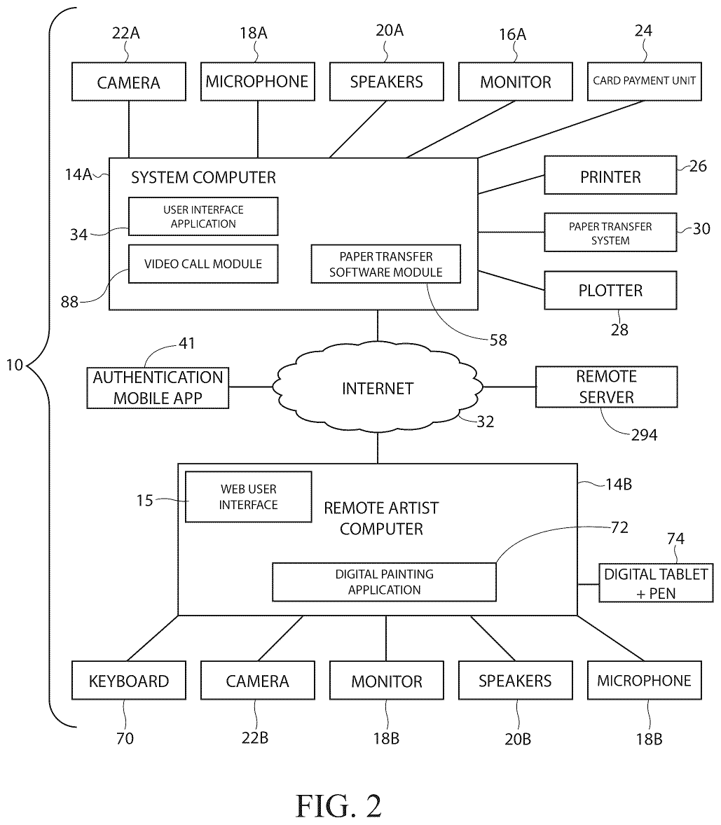

With reference to FIGS. 1-2, the system for the remote creation and delivery of digital portraits 10 is packaged in a photobooth style cabinet 12. The photobooth style cabinet 12 is of sufficient size to accommodate the hardware required to allow an artist to remotely paint a portrait, as well as the hardware required to print out and sign the remotely painted portrait at the cabinet.

The system for the remote creation and delivery of digital portraits 10 includes a computing device 14A. Connected to the computing device 14A are input devices including a monitor 16A which ideally will be a touchscreen monitor, a microphone 18A, speakers 20A, a camera 22A and a card payment unit 24. Also connected to the computing device 14A are output devices including a printer 26 and a pen plotter 28. A paper transfer system 30 controls the flow of paper from the printer 26 to the pen plotter 28 and thereafter to a customer. The computing device 14A is connected to a network 32 such as the internet. The system 10 further includes a user interface application (“UI”) 34 stored in memory on the computing device 14A. The user interface application 34 operates the hardware which comprises the system 10 and generates user interface graphics which allow a customer 36 to interface with the system. The above components of the system for the remote creation and delivery of digital portraits 10 will typically be housed within the photobooth style cabinet 12.

Additional components of the system 10 include a remote computing device 14B to which are connected input devices including a monitor 16B, a microphone 18B, speakers 20B, a camera 22B, a keyboard 70 and a digital tablet and pen 74. Stored in memory on the remote computing device 14B is a digital painting application 72.

With reference to FIGS. 1 and 2, in general, to use the system 10, a customer 36 will access the system by following and responding to options displayed on the touchscreen monitor 16 by the user interface application 34. Initially, the customer 36 will select from a variety of options provided by the system 10. The range of options available includes, but is not limited to portrait painting, image autographing, the purchase of existing artwork such as paintings or photographs, or the creation of new artwork via customer interaction with an artificial intelligence (“AI”) application. Typically, once an option is selected and the artwork purchased or portrait painted, the customer 36 will be required by the system 10 to make payment for the service via a card payment unit 24, which is typically configured to process payments via debit, credit or gift cards.

In a typical case, where a customer 36 selects, for example, the option of portrait painting, a remotely located artist 38 is selected from a menu of available artists. Once the remotely located artist 38 is selected, the customer 36 will use the microphone 18A, speakers 20A and camera 22A to communicate with the remotely located artist. The remotely located artist 38 will typically have a computing device 14B equipped with a monitor 16B, as well as a camera 22B, speakers 20B, a microphone 18B and a keyboard 70 and a digital tablet and pen 74, which he will similarly use to communicate with the customer 36 via the network 32, which is typically the internet. The remote system further includes a web-based user interface, Web UI 15, running on the computing device 14B. The Web UI 15 allows a remotely located artist 38 to communicate, share his workspace, and send finished portrait 78 to the customer 36.

Though not required, it is desirable that the microphone 18A and speakers 20A be of high-fidelity to increase the sense of connection between the customer 36 sitting for a portrait and the remotely located artist 38.

The camera 22A of the system 10 is a video camera for communication between the customer 36 and remotely located artist 38. The camera 22A will typically be equipped with pan, tilt, zoom, and automatic face-tracking capabilities. The user interface application 34 is configured so as to allow the remotely located artist 38 to control the camera 22A, when painting a portrait 78 of a customer 36. The video from the camera 22A is also displayed on the monitor 16A so as to allow a customer 36 to see herself on the display. This provides the customer with feedback on her posing and allows her to adjust her pose to that which is most desired. The photobooth style cabinet 12 is also equipped with a mirror 35 which is positioned and configured to reflect an image of a customer's upper torso. The mirror 35 thereby may also be used by a customer to adjust her posing in addition to the camera video displayed in the monitor 16A.

The remotely located artist 38 controls the camera 22A via a web interface 15 provided by the system 10 and paints the customer's portrait 78 using a digital painting application 72 such as Adobe Illustrator, Adobe Photoshop, ArtRage, Corel Painter, CorelDRAW, Inkscape, TwistedBrush or like applications. These and other digital painting applications are known in the art and are commercially available. Once the portrait 78 is digitally painted, the digital file containing the portrait 78 is transmitted over the network 32 from the remotely located artist's computing device 14B to the computing device 14A, where the portrait 78 is processed for printing on the printer 26. The printer 26 will typically be of photorealistic quality. In a typical case, the portrait 78 is printed using the printer 26 and transported to the pen plotter 28 for signature and customized messaging. Alternatively, the image may be entirely drawn using the pen plotter 28.

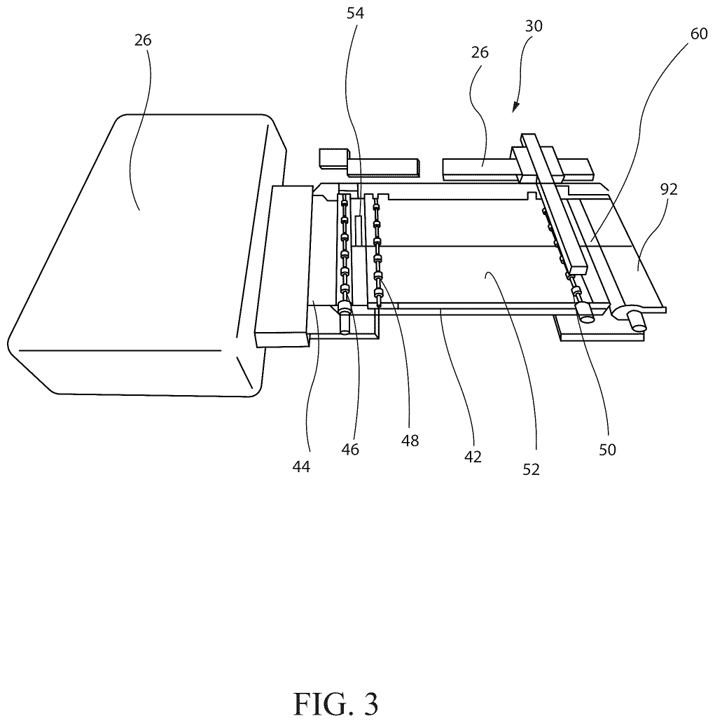

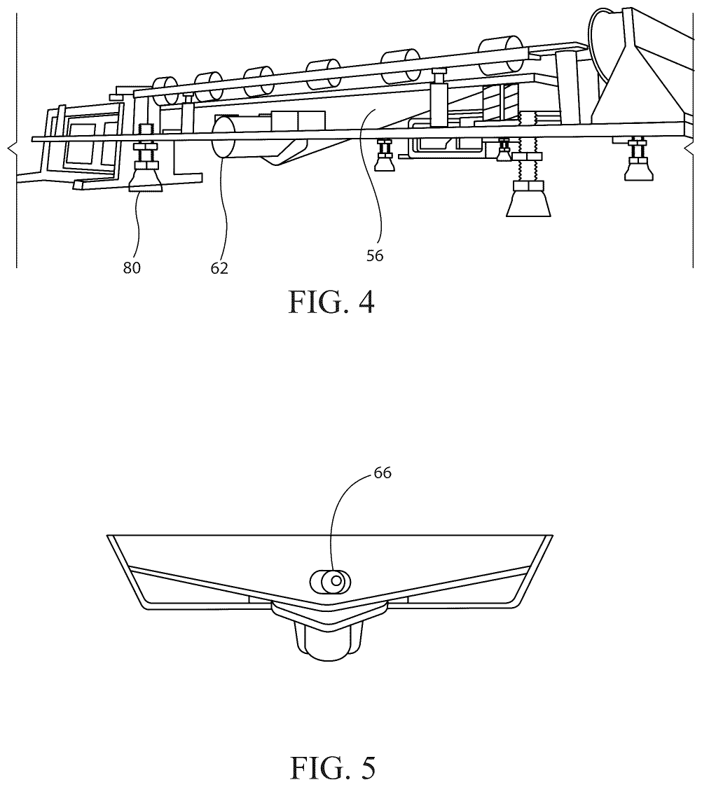

The paper transfer system 30 of the system for the remote creation and delivery of digital portraits 10 is illustrated in FIGS. 3-4. The paper transfer system 30 serves to transfer a sheet of printed paper from the printer 26 to the pen plotter 28. In operation, the paper transfer system 30 extracts a sheet of paper 52 from the printer 26 and places it under the pen plotter 28. The paper transfer system 30 comprises a platen 42 to which is attached a funnel-shaped entry module 44. The funnel-shaped entry module 44 is configured so as to receive a sheet of paper 52 from the printer 26 and align the paper for transport onto the platen 42. Transport of the paper is carried out by means of a first set of pinch rollers 46, a second set of pinch rollers 48 and a third set of pinch rollers 50.

An electronic paper sensor 54 informs a paper transfer software module 58 (see FIG. 2) of the presence of a sheet of paper 52. When a sheet of paper is detected by the electronic paper sensor 54, the paper transfer software module 58 activates the first and second sets of pinch rollers 46 and 48, and at the same time activates a paper pinch tray 56 (see FIG. 4). The paper pinch tray 56 is disposed under the first set of pinch rollers 46 and allows for free movement of the paper 52 during operation of the printer 26.

Upon being directed by the paper transfer software module 58, the paper pinch tray 56 pinches a sheet of paper 52 against the first set of pinch rollers 46 so that it advances forward and is engaged by the second set of pinch rollers 48. Thereafter, the second set of pinch rollers 48 advances the paper until it is engaged by the third set of pinch rollers 50.

Upon a sheet of paper 52 advancing sufficiently to engage the third set of pinch rollers 50, the paper transfer software module 58 turns off the pinch rollers 46, 48 and 50, leaving the paper 52 centered on the platen 42. The sets of pinch rollers 46, 48 and 50 function both to advance the paper and to hold it securely on the platen 42 during operation of the pen plotter 28. An exit flap 60 is provided, so that upon completion of an image, the paper transfer system 30 may either advance the sheet of paper 52 to a trash receptacle or advance the paper out of the photobooth style cabinet 12 to a waiting customer.

With reference to FIGS. 4-5, the paper pinch tray 56 is activated by a stepper motor 62 in response to a signal from the paper transfer software module 58. A cam lobe 66 on the stepper motor output shaft raises and lowers the paper pinch tray 56. (See FIG. 5.) In the raised position, the paper pinch tray 56 presses the paper 52 against the first set of pinch rollers 46 causing the paper to advance. Alternatively, a linear stepper motor can be used to raise and lower the paper pinch tray 56, without requiring the cam lobe 66.

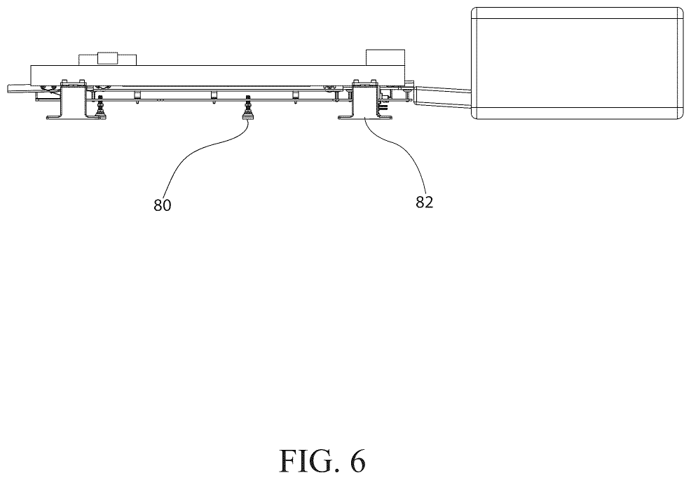

With reference to FIG. 6, adjustable legs 80 and blocks 82 are disposed on a bottom panel of the paper transfer system 30. The adjustable legs 80 and blocks 82 allow the height of the paper transfer system 30 and the pen plotter 28 to be adjusted so as to be compatible with a variety of printers, which typically do not have standardized heights for their paper output slots.

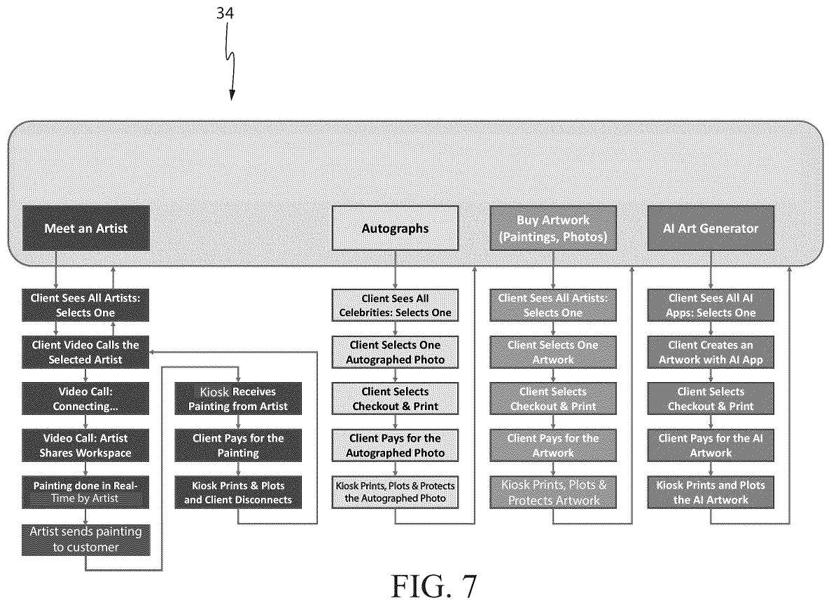

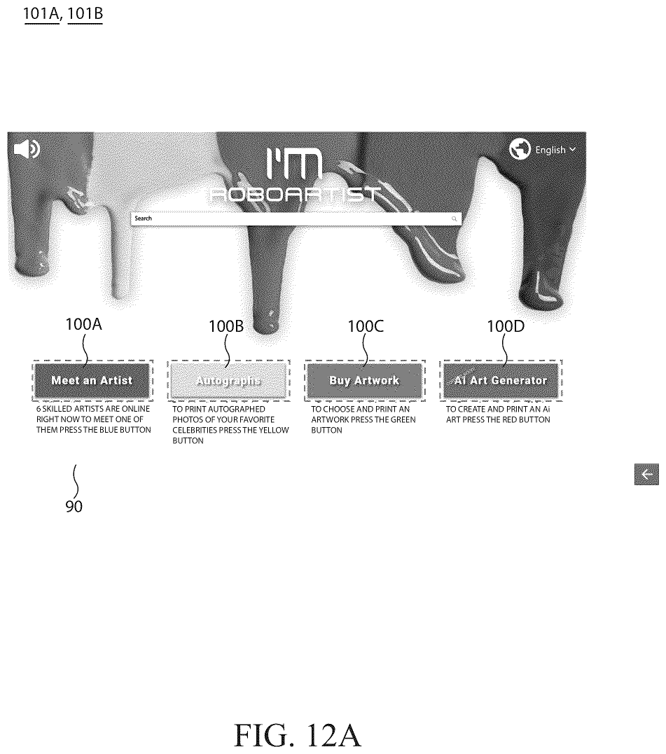

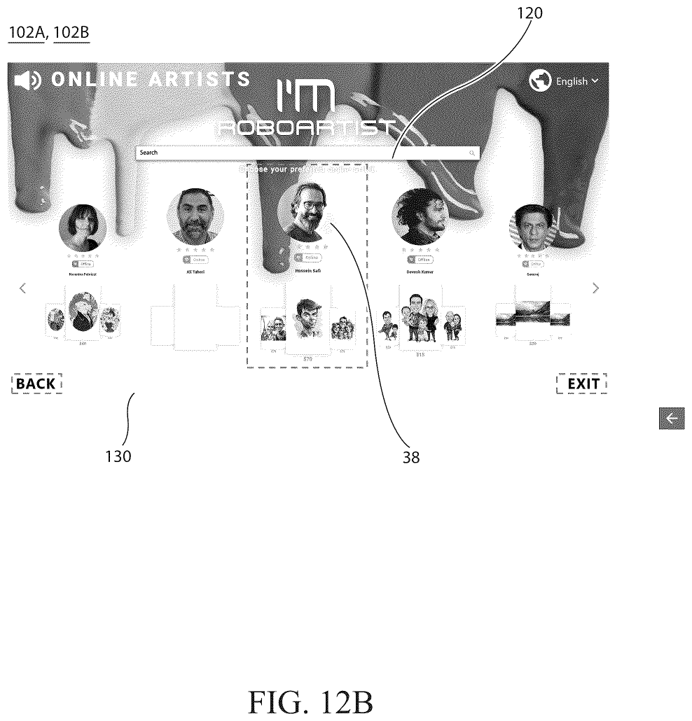

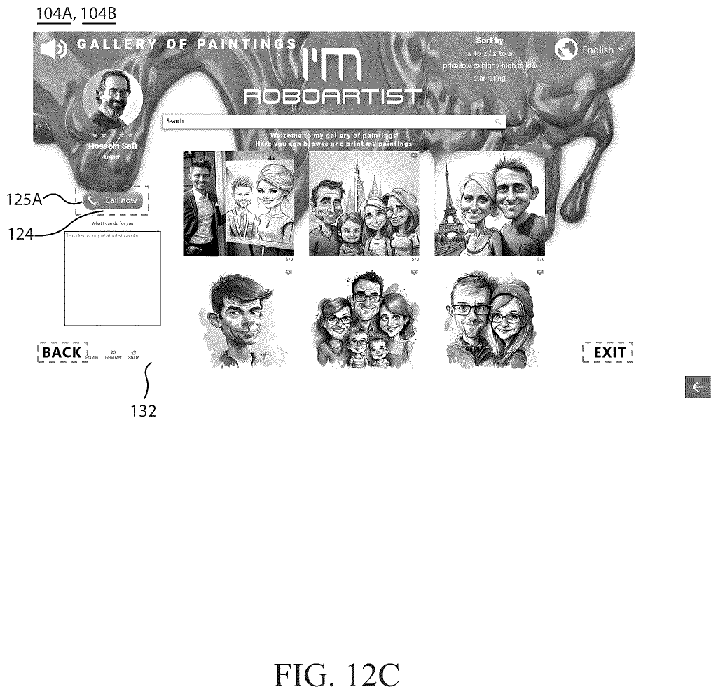

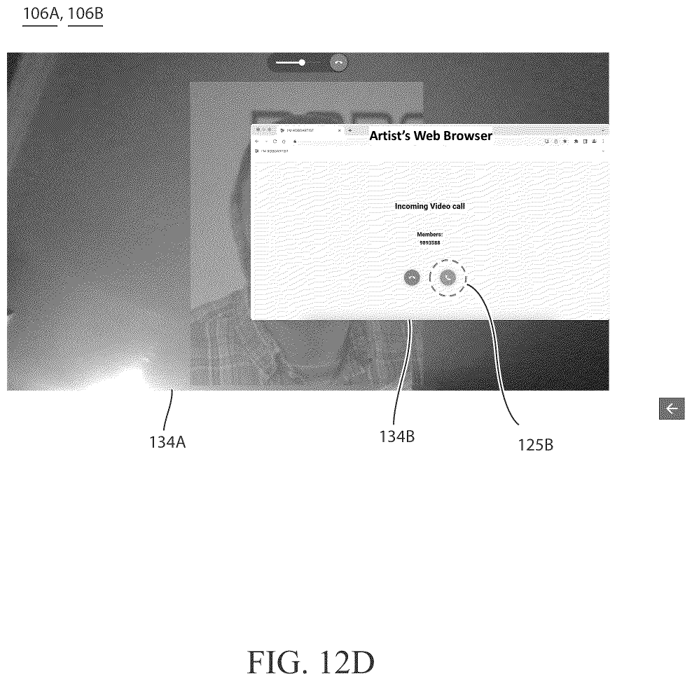

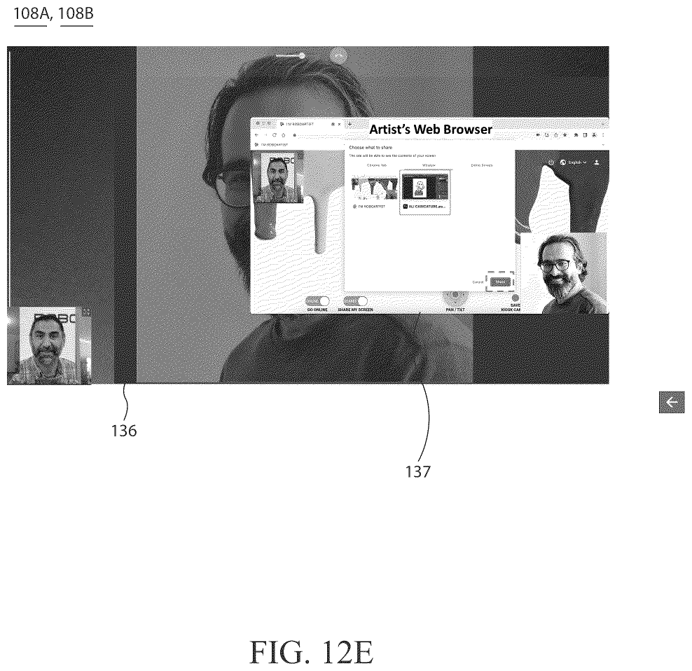

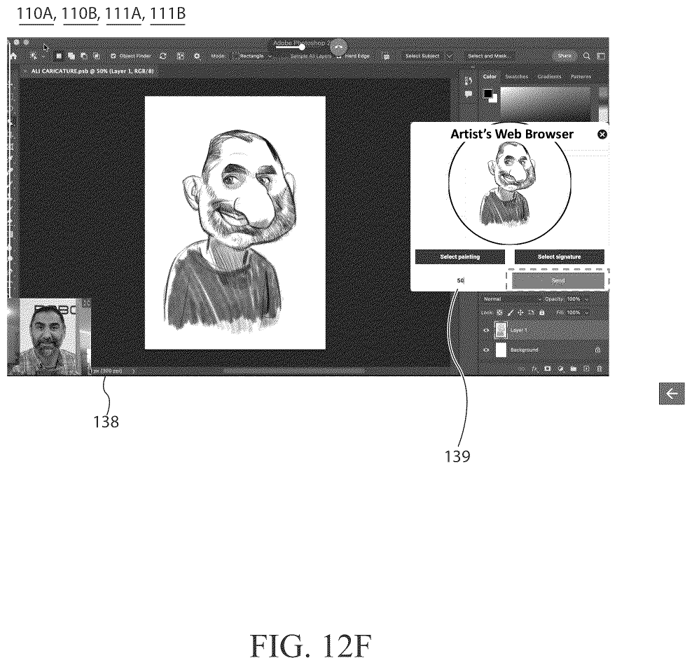

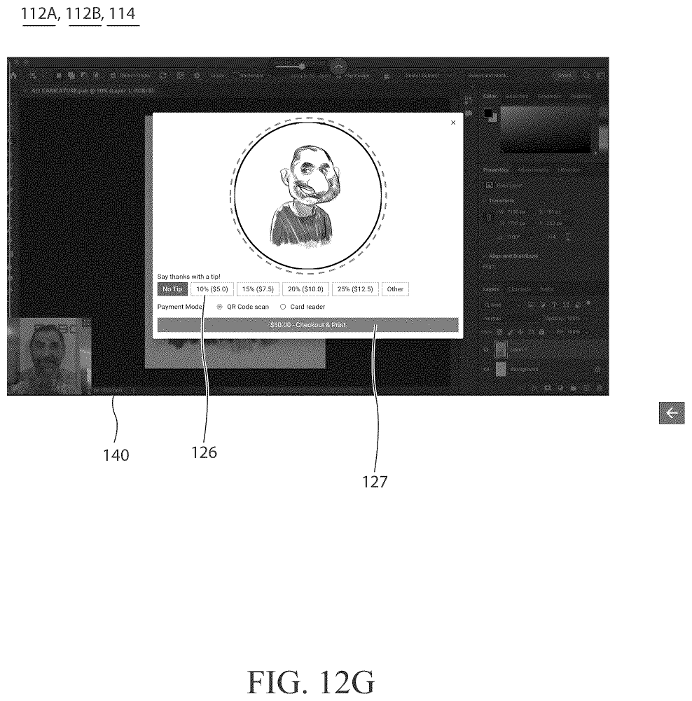

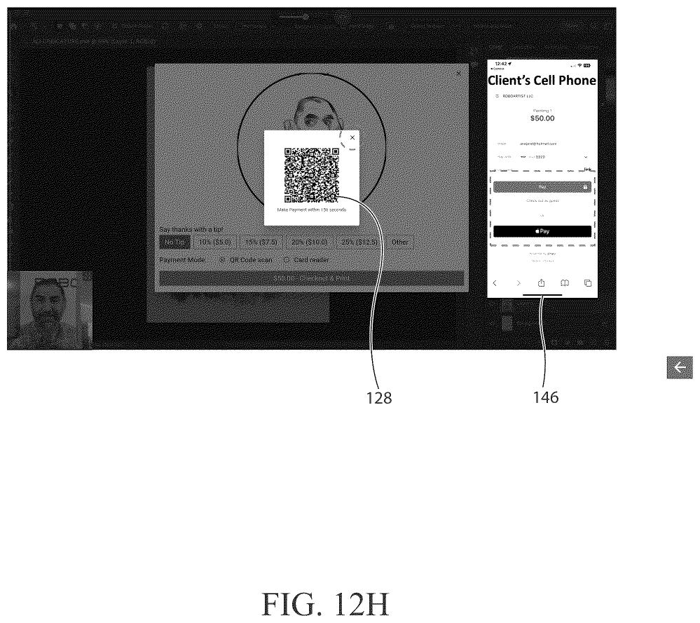

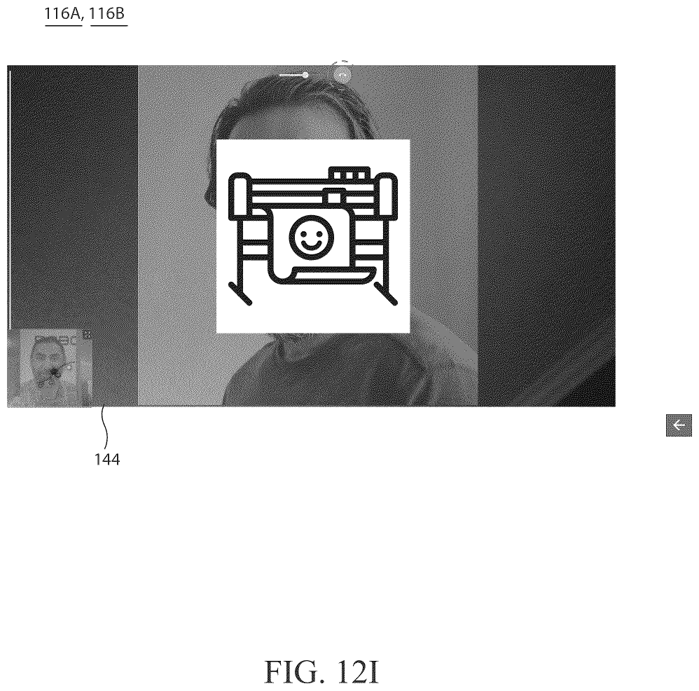

With reference to FIG. 7, an exemplary flow diagram of the UI 34 of the of system for the remote creation and delivery of digital portraits 10 of the present invention is shown. With reference to FIG. 12A, an exemplary start screen 90 of the UI 34 is shown. The start screen 90 displays options for meeting a remote artist for the purpose of having a portrait digitally painted (option 100A); purchasing autographed artwork (option 100B); buying preexisting artwork (option 100C); and, having new artwork created using an AI artwork generator (option 100D).

### Digital Portrait Painting Option

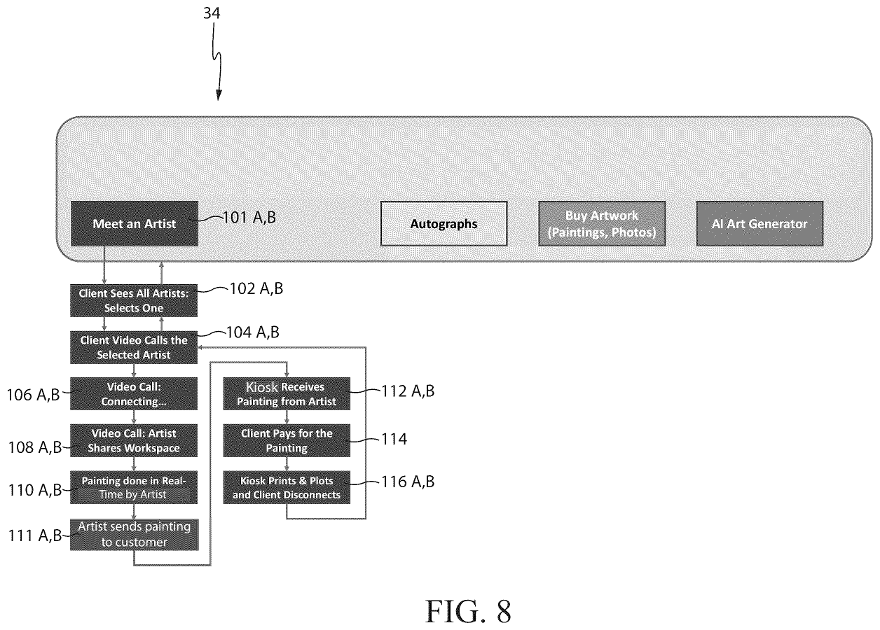

With reference to FIG. 8, a flow diagram showing process steps 101A through 116B for having a portrait digitally painted are presented. Each step of the process is described in more detail below with reference to FIGS. 12A to 12J, which depict exemplary displayed screens generated by the UI 34.

With reference to FIG. 12A, the start screen 90 is depicted. In step 101A, the UI 34 creates and displays on the monitor 16A, the start screen 90. Subsequently in step 101B, in order to have a portrait digitally painted, the customer 36 selects the “Meet an Artist” option 100A displayed in the start screen 90.

With reference to FIG. 12B, an exemplary search and navigation screen 130 is depicted. In step 102A, the UI 34 creates and displays on the monitor 16A, the search and navigation screen 130, which allows a customer 36 to search a database of remote artists 120 who are available to paint the customer's portrait. Subsequently in step 102B, the customer 36 navigates through the artists displayed on the monitor 16A and selects a particular remotely located artist 38 to paint his portrait 78.

With reference to FIG. 12C, an exemplary video call screen 132 is depicted. In step 104A, the UI 34 creates and displays on the monitor 16A, the video call screen 132. Subsequently in step 104B, the customer 36 initiates a video call 124 with the remotely located artist 38 that he has selected. The video call 124 is implemented via a video call module 88 upon the customer's pressing a video call button 125A.

With reference to FIG. 12D, an exemplary outgoing video call screen 134A showing a graphical representation of an outgoing video call 124, is depicted. In step 106A, the UI 34 creates and displays on the monitor 16A, the outgoing video call screen 134A, and the Web UI 15 creates and displays on the monitor 16B, the incoming video call screen 134B. In step 106B, the remotely located artist 38 accepts the incoming video call 124 by pressing the button 125B to establish audio/visual communications with the customer 36.

With reference to FIG. 12E, exemplary workspace sharing screens 136 and 137 for a virtual workspace, are depicted. In step 108A, the UI 34 creates and displays on the monitor 16A the workspace sharing screen 136. Subsequently in step 108B, the remotely located artist 38 uses the Web UI 15 and shares workspace sharing screen 137 with the customer 36. By sharing his workspace sharing screen 137, the remotely located artist 38 gains control over the camera 22A in the remotely photo booth style cabinet 12.

With reference to FIG. 12F, an exemplary painting progress screen 138, is depicted. In step 110A, the UI 34 creates and displays the painting progress 138 on the monitor 16A, which allows the customer 36 to watch his portrait being digitally painted. In step 110B, the remotely located artist 38 digitally paints the customer's portrait 78 using a digital painting application 72 such as Adobe Illustrator, Adobe Photoshop, ArtRage, Corel Painter, CorelDRAW, Inkscape, TwistedBrush or like commercially available painting application.

With continued reference to FIG. 12F, in step 111A, the Web UI 15 creates a painting transmittal screen 139. In step 111B, the remotely located artist 38 uses the painting transmittal screen 139 to send the portrait 78, now finished, to the customer 36, along with the price.

With reference to FIG. 12G, an exemplary payment screen 140, is depicted. In step 112A, the UI 34 creates and displays on the monitor 16A, the exemplary payment screen 140. Subsequently, in step 112B, the system computer 14A receives the portrait 78, now completed, and the UI 34 displays the completed portrait 78, along with the price and the tipping option 126.

With continued reference to FIG. 12G, in step 114, the customer 36 selects one of the payment options presented and presses the “Checkout & Print” button 127 and pays for the portrait 78 using the selected option. The payment screen 140 will typically provide the customer with the option of paying by either credit or debit card using the card payment unit 24 or via a QR code 128 (see FIG. 12H).

With reference to FIG. 12H if the option to pay by QR code is selected in step 114, upon scanning the QR code by a customer mobile computing device, such as a customer cell phone 40 (see FIG. 1), the customer cell phone 40 communicates with the server 294, which makes the customer cell phone 40 display a payment processing screen 146 and the steps to follow to make the payment using the customer cell phone 40.

With reference to FIG. 12I an exemplary print status screen 144, is depicted. In step 116A, the UI 34 creates and displays the print status screen 144 on monitor 16A. While displaying the print status screen 144, the UI 34 prints the finished portrait 78 using the printer 26 and/or pen plotter 28 located in the photobooth style cabinet 12. In step 116B, the customer picks up his portrait 78 from a pickup tray 92 in the photobooth style cabinet 12. Optionally, the portrait 78 may be printed offsite and shipped to the customer.

### Autographed Celebrity Portrait Option

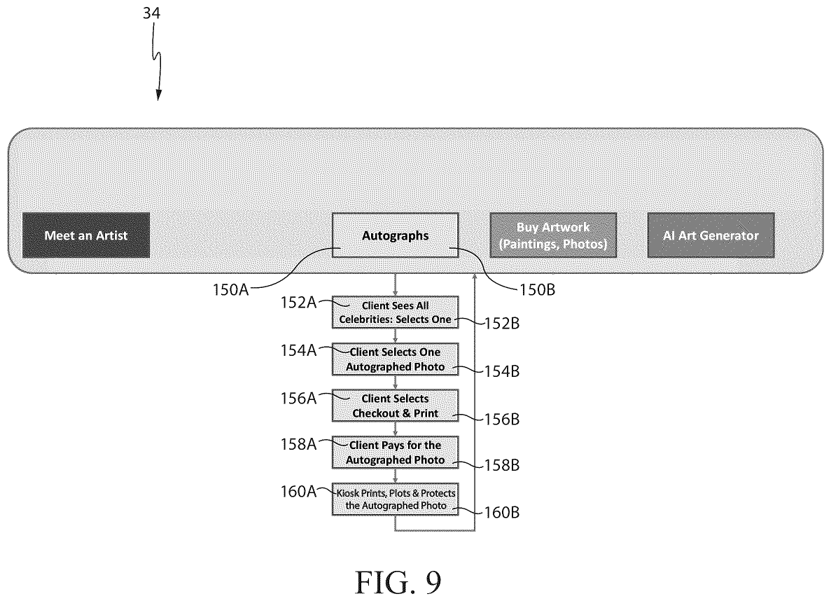

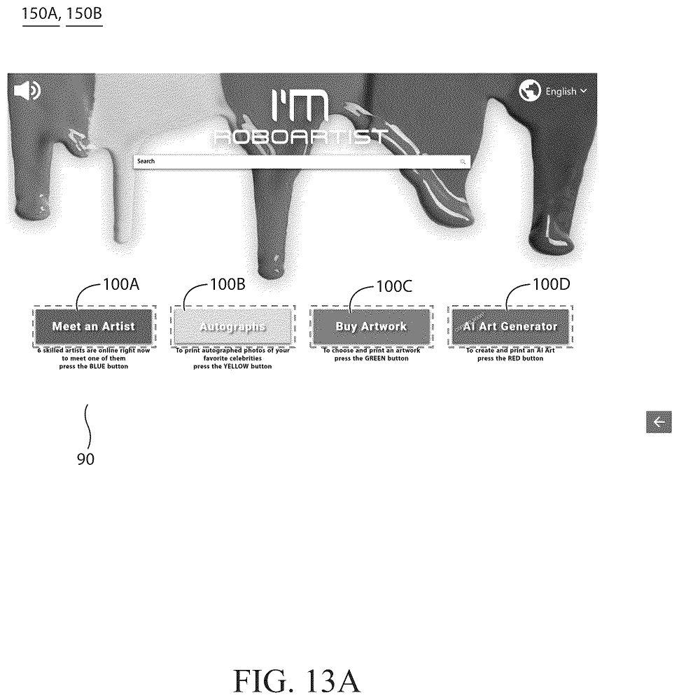

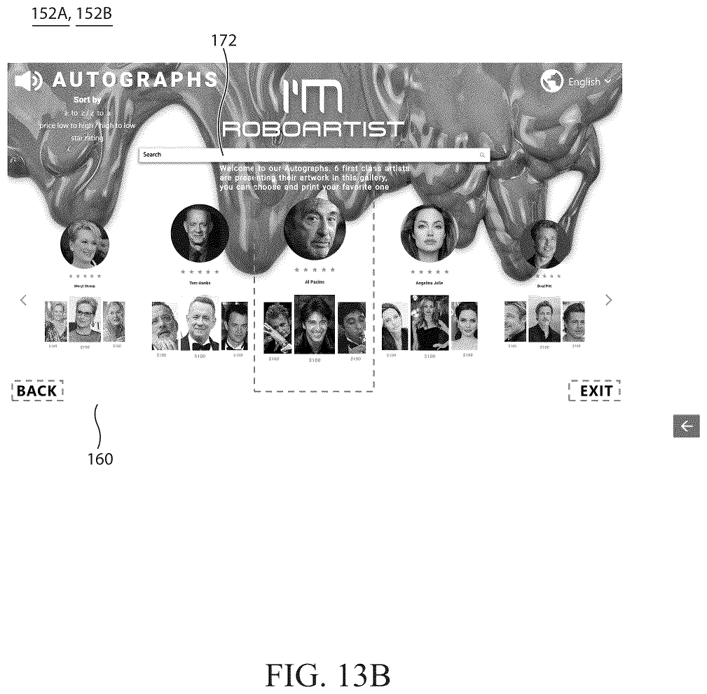

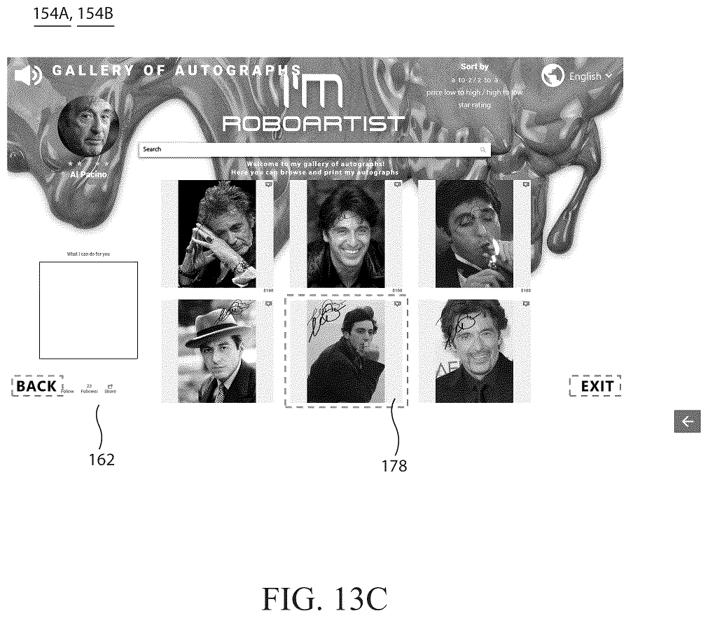

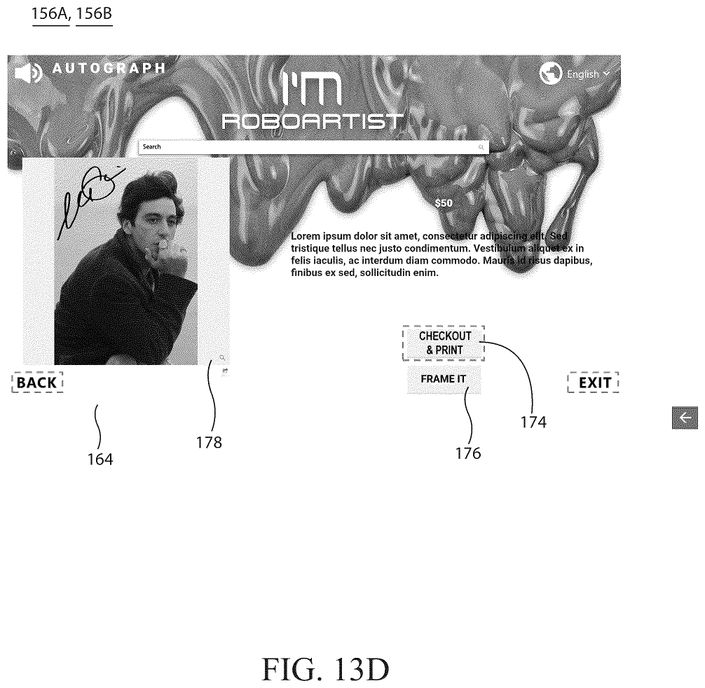

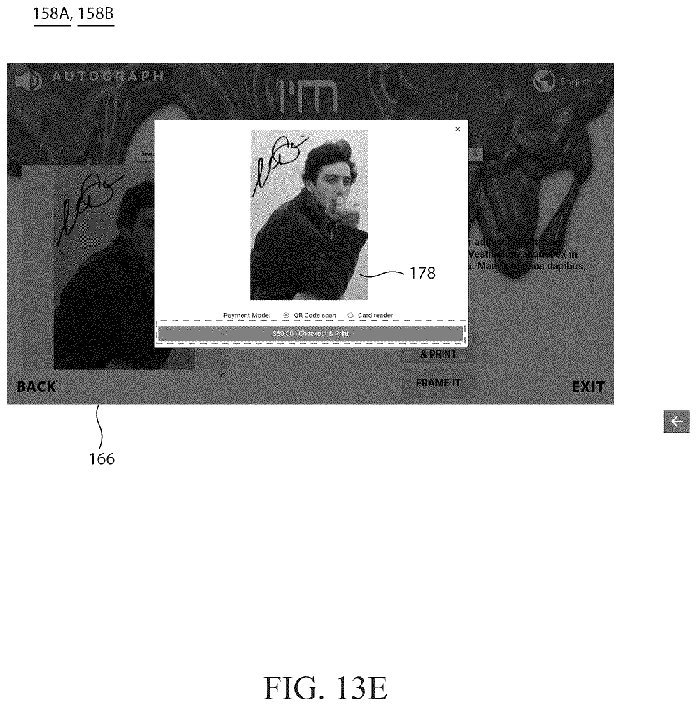

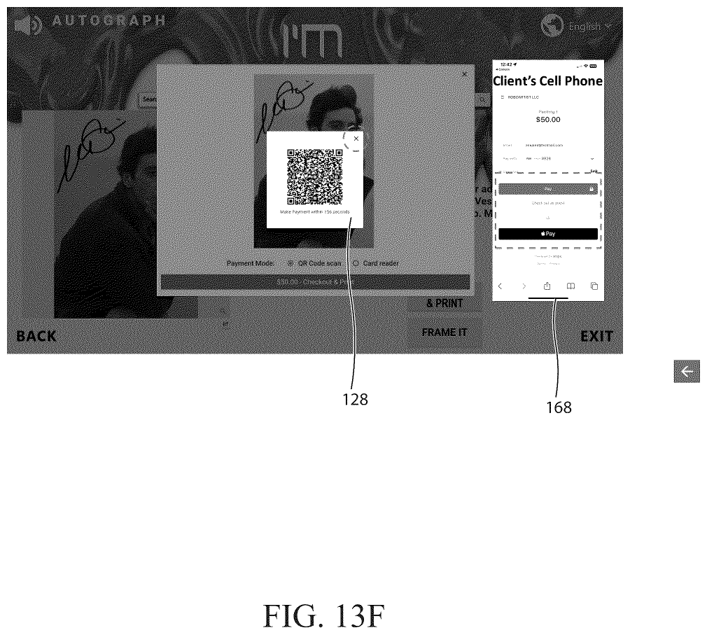

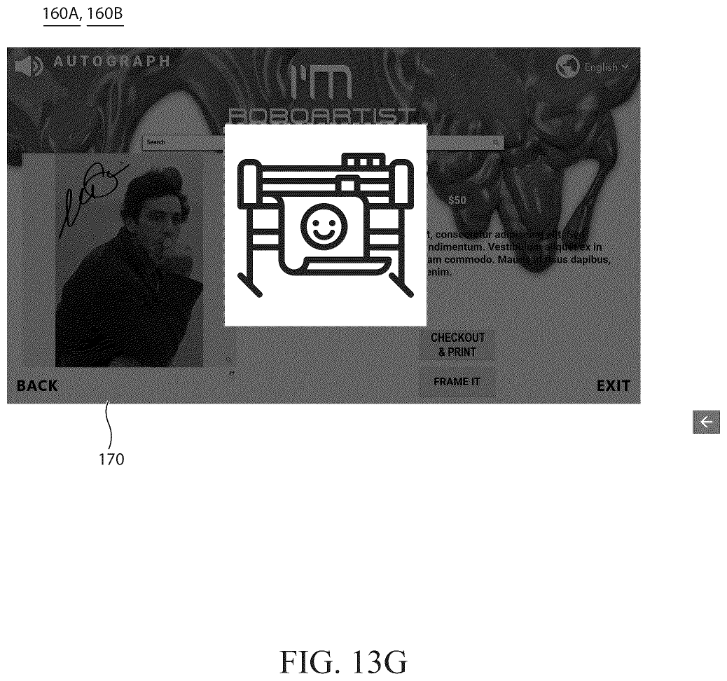

With reference to FIG. 9, a flow diagram showing process steps 150A through 160B for selecting a celebrity photo to be autographed, are presented. Each step of the process is described in more detail below with reference to FIGS. 13A to 13G, which depict exemplary display screens generated by the UI 34.

With reference to FIG. 13A, the start screen 90 is depicted. In step 150A, the UI 34 creates and displays on the monitor 16A, the start screen 90. Subsequently in step 150B, the customer 36 selects the “Autographs” option 100B displayed in the start screen 90.

With reference to FIG. 13B, an exemplary search and navigation screen 160 is depicted. In step 152A, the UI 34 creates and displays on the monitor 16A, the search and navigation screen 160, which allows a customer 36 to search a database of autographed celebrity photographs 172 which are available to be printed. Subsequently in step 152B, the customer 36 navigates through the celebrities displayed on the monitor 16A and selects a particular celebrity.

With reference to FIG. 13C, an exemplary celebrity photo display screen 162 is depicted. In step 154A, the UI 34 creates and displays on the monitor 16A, the celebrity photo display screen 162, which allows a customer 36 to select one of the autographed of celebrity photographs for the celebrity searched in step 152B, for printing. Subsequently in step 154B, the customer 36 selects a desired autographed celebrity photograph for printing.

With reference to FIG. 13D, an exemplary checkout screen 164 displaying the celebrity photo selected, is depicted. In step 156A, the UI 34 creates and displays on the monitor 16A, the checkout screen 164, which includes a framing option. In step 156B, the customer 36 selects either the “Checkout & Print” option 174 or “Frame It” option 176. If the “Frame It” option 176 is selected, the selected autographed celebrity photograph 178 is printed offsite and shipped to the customer 36, after payment is made.

With reference to FIG. 13E, an exemplary payment screen 166, is depicted. In step 158A, the UI 34 creates and displays on the monitor 16A, the payment screen 166. The payment screen 166 will typically provide the customer with the option of paying by either credit or debit card using the card payment unit 24 or via a QR code 128 (see FIG. 13F). Subsequently, in step 158B, the customer 36 pays for the autographed celebrity photograph 178 using either of the options presented.

With reference to FIG. 13F, if the option to pay by QR code is selected, upon scanning the QR code by a customer mobile computing device, such as a customer's cell phone 40 (see FIG. 1), the customer cell phone 40 communicates with the server 294, which makes the customer cell phone 40 display the payment screen 168 and the steps to follow to make the payment using the customer's cell phone 40.

With reference to FIG. 13G an exemplary print status screen 170, is depicted. In step 160A, the UI 34 creates and displays the print status screen 170 on monitor 16A. While displaying the print status screen 170, the UI 34 prints the celebrity photograph 178 using the printer 26 and autographs the celebrity photograph 178 with the pen plotter 28, both of which are located in the photobooth style cabinet 12. In step 160B, the customer picks up his autographed photograph 178 from a pickup tray 92 in the photobooth style cabinet 12.

### Buy Artwork Option

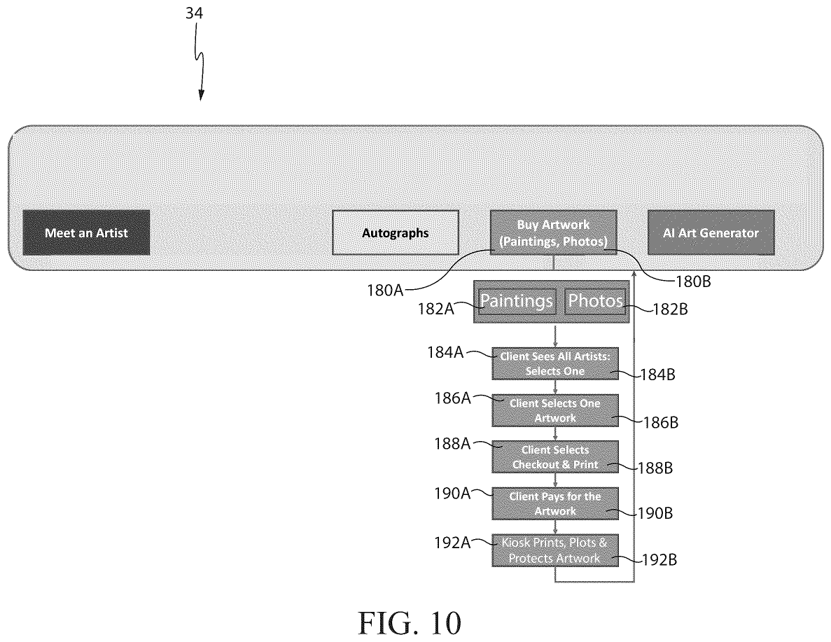

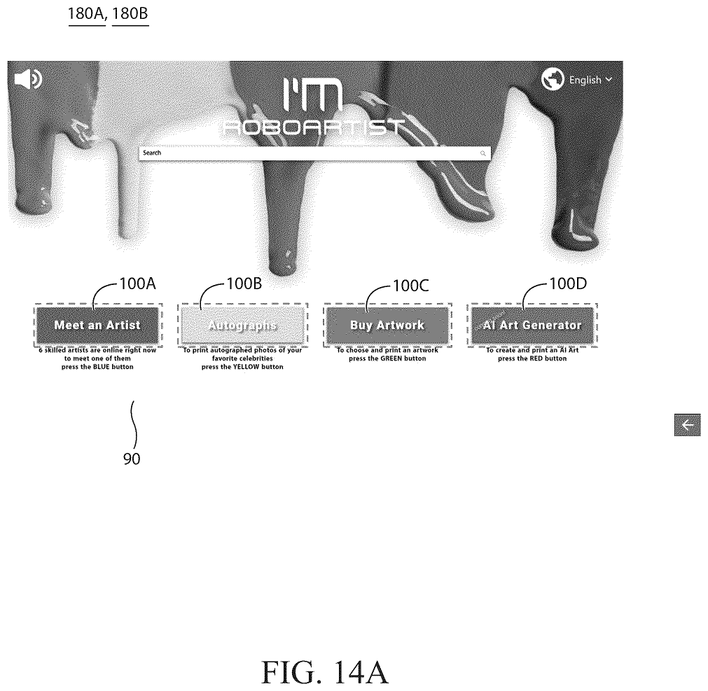

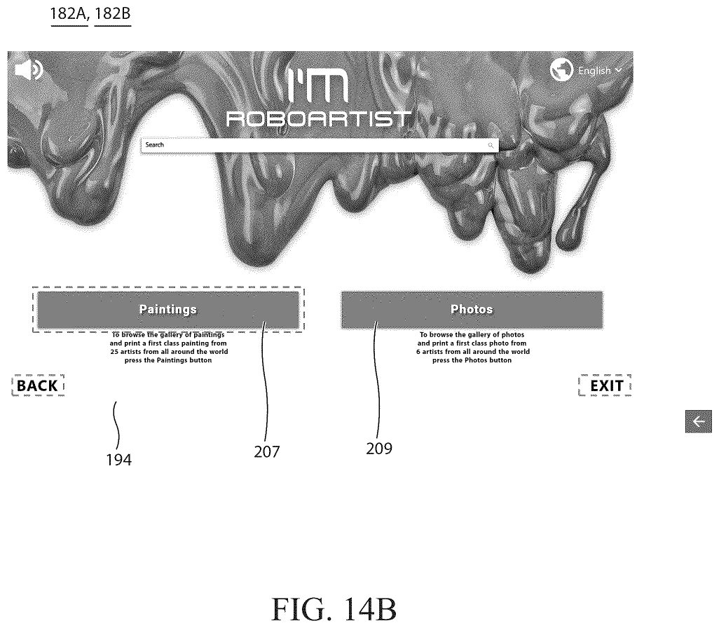

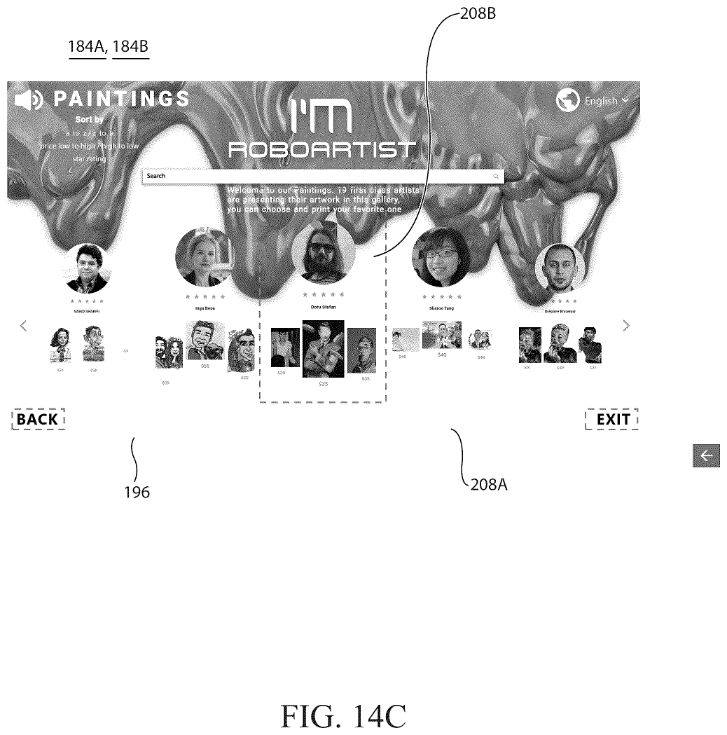

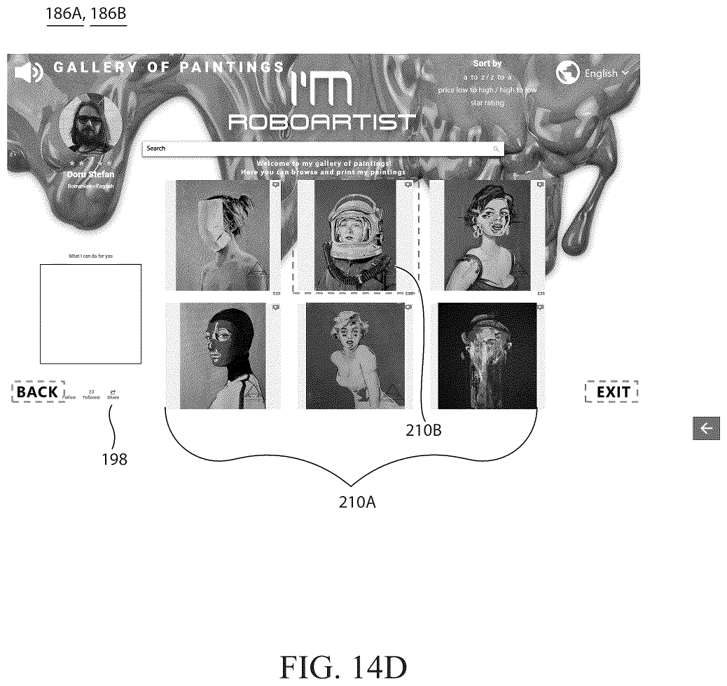

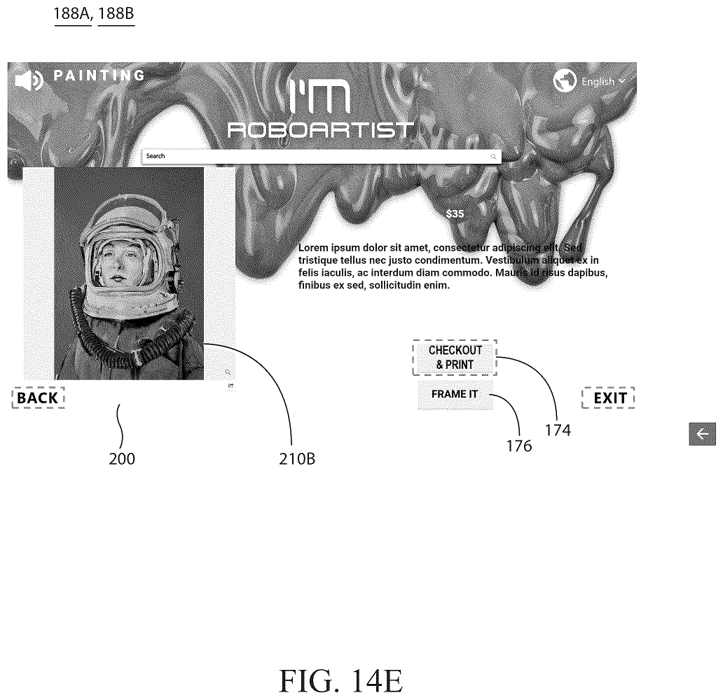

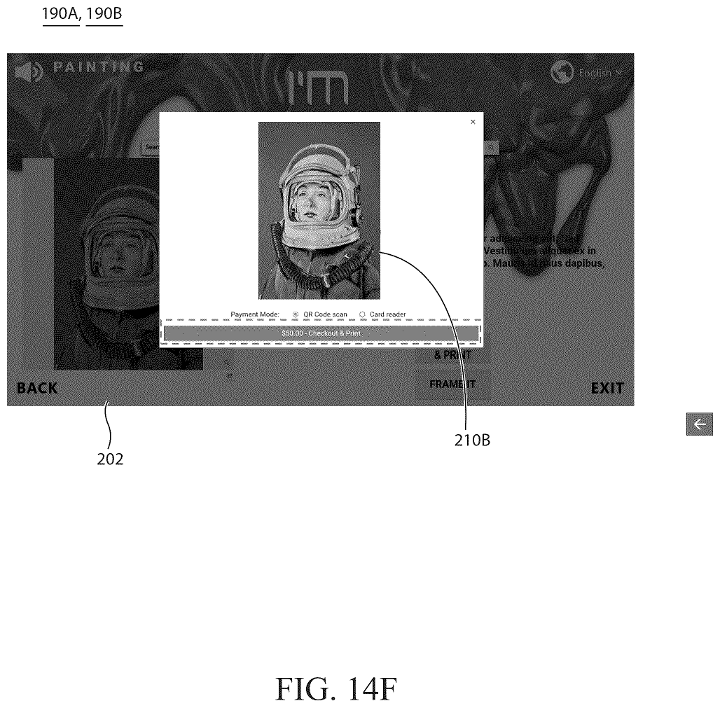

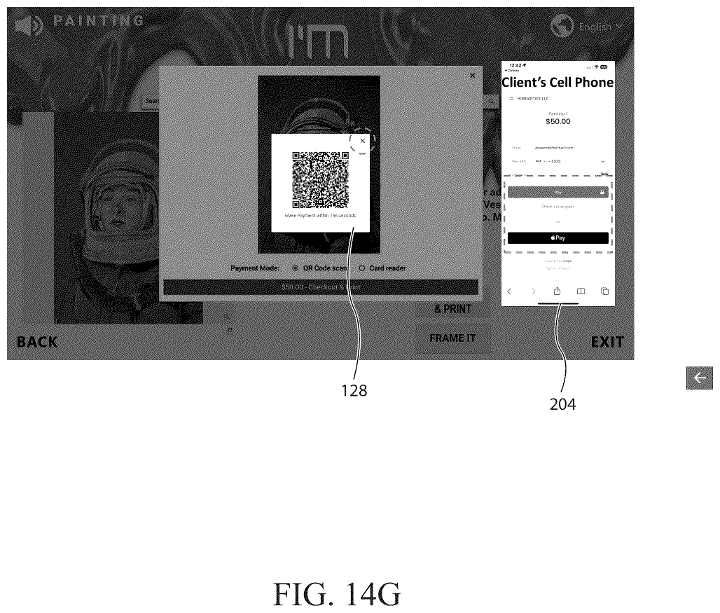

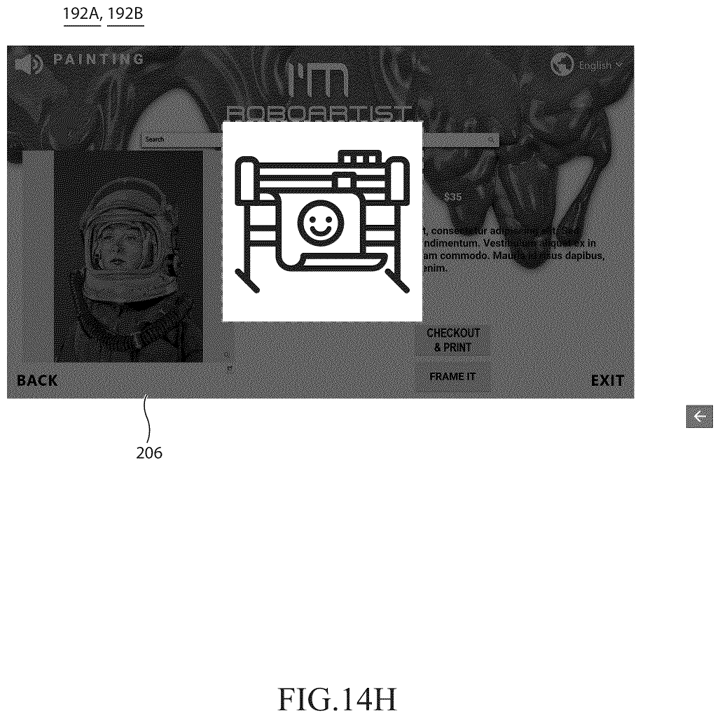

With reference to FIG. 10, a flow diagram showing process steps 180A through 192B for selecting artwork available for purchase, is presented. Each step of the process is described in more detail below with reference to FIGS. 14A to 14H, which depict exemplary display screens generated by the UI 34.

With reference to FIG. 14A, the start screen 90 is depicted. In step 180A, the UI 34 creates and displays on the monitor 16A, the start screen 90. Subsequently in step 180B, the customer 36 selects the “Buy Artwork” option 100C displayed in the start screen 90.

With reference to FIG. 14B, an exemplary artwork type selection screen 194 is depicted. In step 182A, the UI 34 creates and displays on the monitor 16A, the artwork type selection screen 194, which allows a customer 36 to select the type of artwork, either the “Paintings” option 207 or “Photos” option 209, which are available to be printed.

With reference to FIG. 14C, an exemplary search and navigation screen 196 is depicted. In step 184A, the UI 34 creates and displays on the monitor 16A, the search and navigation screen 196, which allows a customer 36 to search a database of artists 208A who have artwork available for sale. Subsequently in step 184B, the customer 36 navigates through the database of artists 208A displayed on the monitor 16A and selects a particular artist 208B.

With reference to FIG. 14D, an exemplary artwork display screen 198 is depicted. In step 186A, the UI 34 creates and displays on the monitor 16A, the artwork display screen 198, which allows a customer 36 to select an artwork 210B from a sub-database of artworks 210A available from the artist 208B selected in step 184B. Subsequently in step 186B, the customer 36 selects a desired artwork 210B for printing.

With reference to FIG. 14E, an exemplary checkout screen 200, is depicted. In step 188A, the UI 34 creates and displays on the monitor 16A, the checkout screen 200, which includes a framing option. In step 188B, the customer 36 selects either the “Checkout & Print” option 174 or “Frame It” option 176. If the “Frame It” option 176 is selected, the selected artwork 210B is printed offsite and shipped to the customer 36, after payment is made.

With reference to FIG. 14F, an exemplary payment screen 202 displaying the selected artwork 210B, is depicted. In step 190A, the UI 34 creates and displays on the monitor 16A, the payment screen 202. The exemplary payment screen 202 provides the customer 36 with the option of paying by either credit or debit card using the card payment unit 24 or via a QR code 128 (see FIG. 14G). Subsequently, in step 190B, the customer 36 pays for the selected artwork 210B using either of the options presented.

With reference to FIG. 14G, if the option to pay by QR code 128 is selected, upon scanning the QR code by a customer mobile computing device, such as a customer's cell phone 40 (see FIG. 1), the customer cell phone 40 communicates with the server 294, which makes the customer cell phone 40 display the payment screen 204 and the steps to follow to make the payment using the customer's cell phone 40.

With reference to FIG. 14H an exemplary print status screen 206, is depicted. In step 192A, the UI 34 creates and displays the print status screen 206 on monitor 16A. While displaying the print status screen 206, the UI 34 prints the selected artwork 210B using the printer 26 and, if needed, the pen plotter 28, both of which are located in the photobooth style cabinet 12. In step 192B, the customer picks up the selected artwork 210B from a pickup tray 92 in the photobooth style cabinet 12.

### Artificial Intelligence Artwork Generation Option

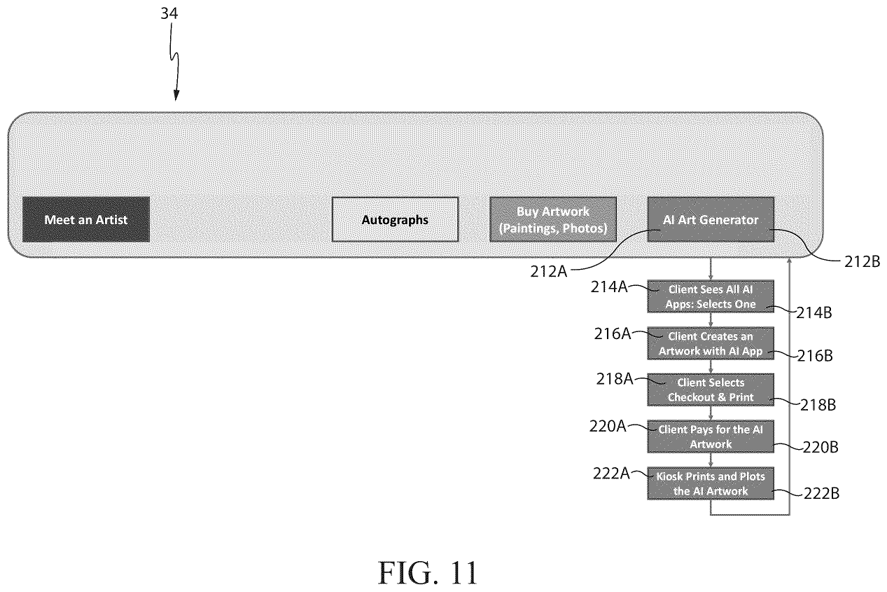

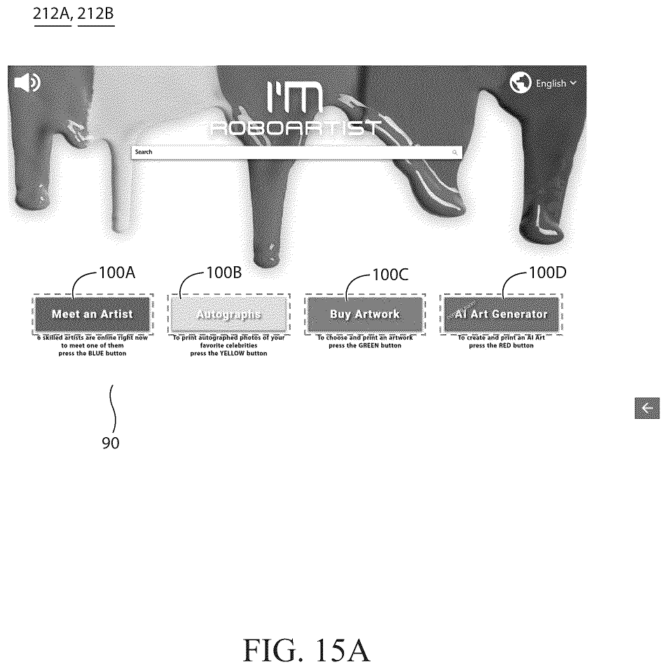

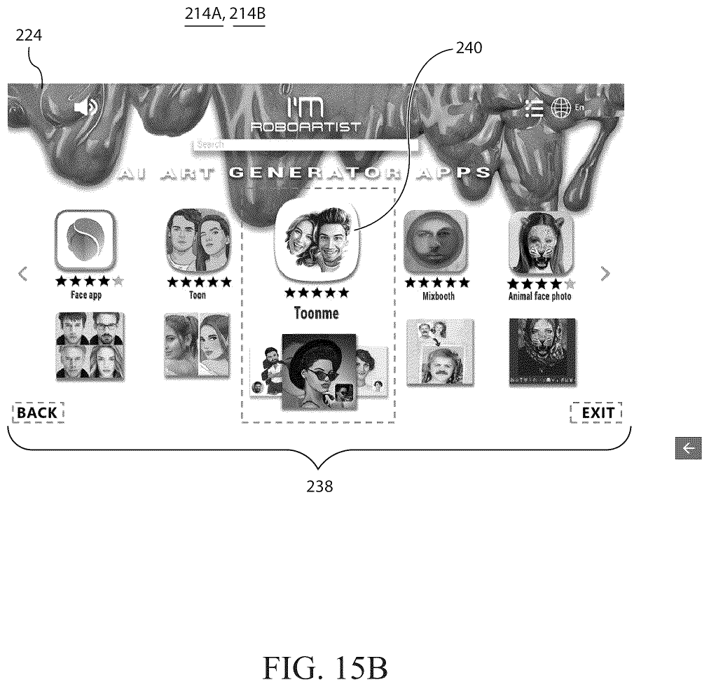

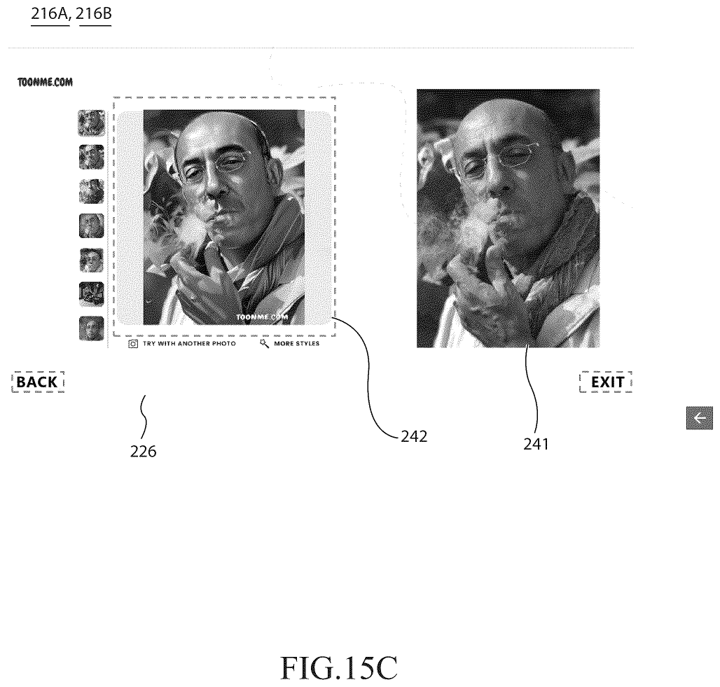

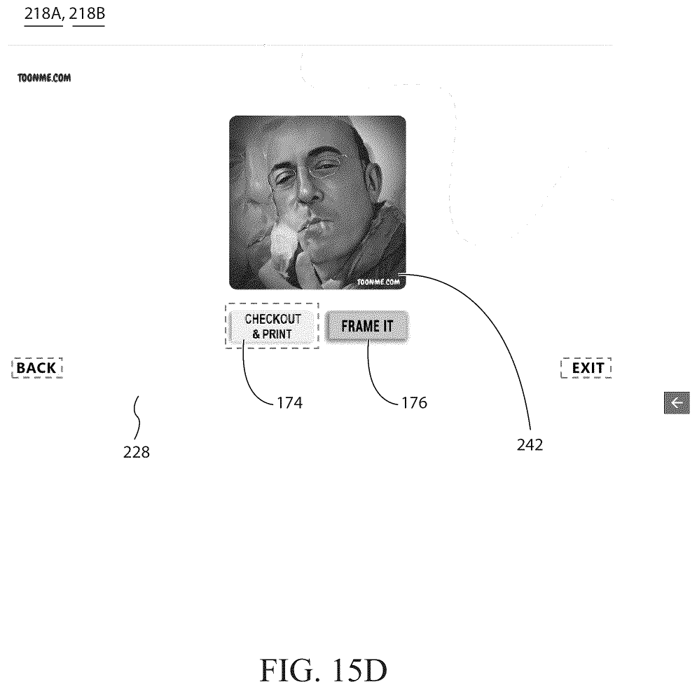

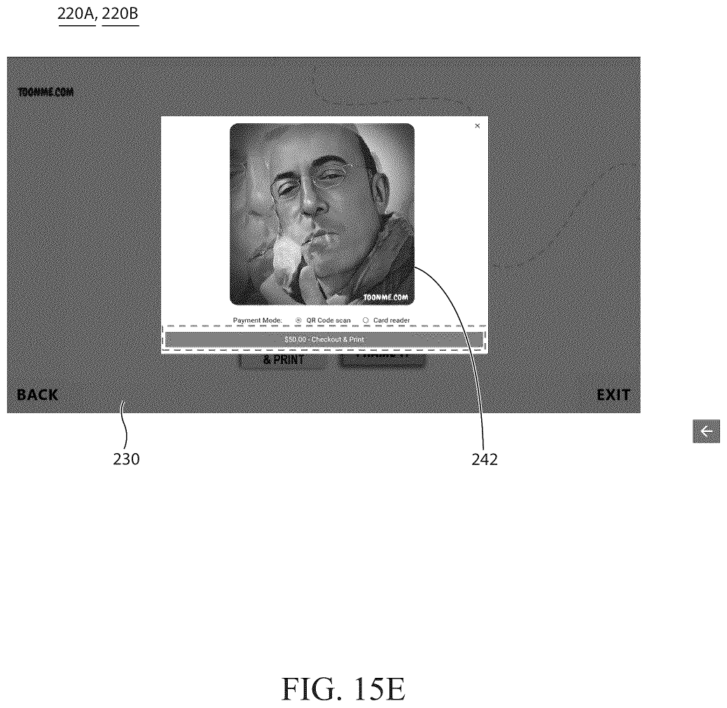

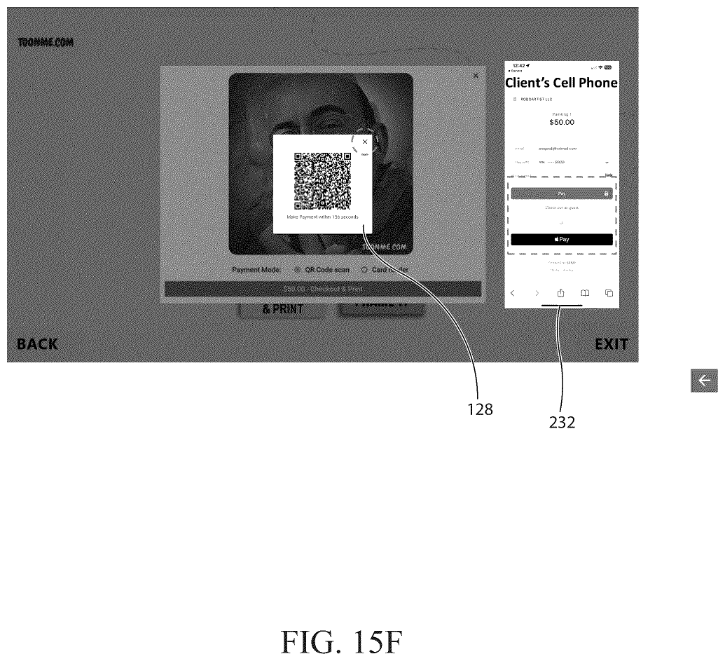

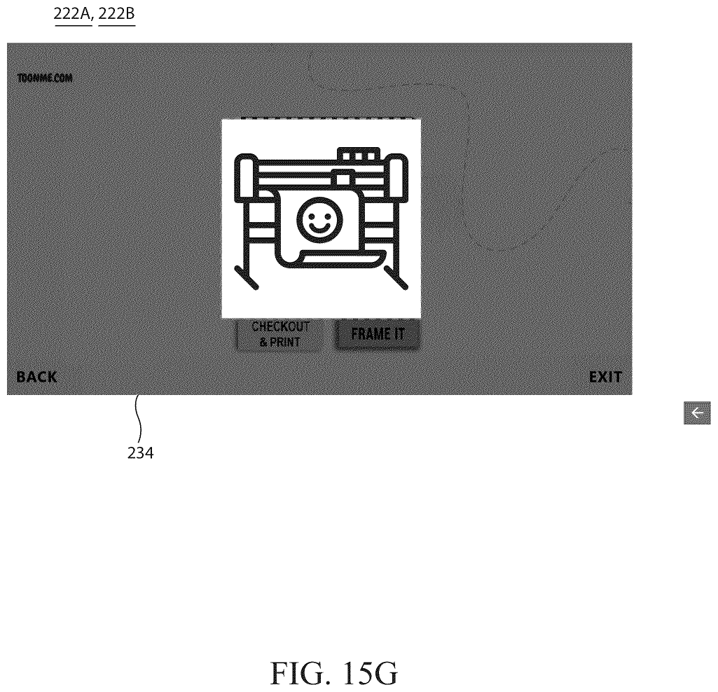

With reference to FIG. 11, a flow diagram showing process steps 212A through 222B for having an artwork generated by an artificial intelligence (“AI”), is presented. Each step of the process is described in more detail below with reference to FIGS. 15A to 15G, which depict exemplary display screens generated by the UI 34.

With reference to FIG. 15A, the start screen 90 is depicted. In step 212A, the UI 34 creates and displays on the monitor 16A, the start screen 90. Subsequently in step 212B, the customer 36 selects the “AI Art Generator” option 100D displayed in the start screen 90.

With reference to FIG. 15B, an exemplary AI artwork generator program selection screen 224 showing a database of AI artwork generator programs 238, is depicted. In step 214A, the UI 34 creates and displays on the monitor 16A, the AI artwork generator program selection screen 224, which allows a customer 36 to select a particular AI artwork generator program 240 from the database of AI artwork generation programs 238. In step 214B, the customer 36 selects a particular AI artwork generator program 240 to use to produce an artwork.

With reference to FIG. 15C, an exemplary program screen 226 showing the particular AI artwork generator program 240 selected by the customer 36, is depicted. The program screen 226, allows the customer to use the selected AI artwork generator program 240 to create an AI generated work 242 from an original picture 241 uploaded with the customer's cell phone 40 (using NFC or another method). In step 216A, the UI 34 creates and displays on the monitor 16A, the program screen 226 with the particular AI artwork generator program 240, selected by the customer 36. In step 216B, the customer 36 uses the selected AI artwork generator program 240 to create an artwork 242 from an original picture 241 uploaded with the customer's cell phone 40 (using NFC or another method).

With reference to FIG. 15D, an exemplary checkout screen 228, is depicted. In step 218A, the UI 34 creates and displays on the monitor 16A, the checkout screen 228, which includes a framing option. In step 218B, the customer 36 selects either the “Checkout & Print” option 174 or “Frame It” option 176. If the “Frame It” option 176 is selected, the AI generated artwork 242 is printed offsite and shipped to the customer 36, after payment is made.

With reference to FIG. 15E, an exemplary payment screen 230 displaying the AI generated artwork 242, is depicted. In step 220A, the UI 34 creates and displays on the monitor 16A, the payment screen 230. The exemplary payment screen 230 provides the customer 36 with the option of paying by either credit or debit card using the card payment unit 24 or via a QR code 128 (see FIG. 15F). Subsequently, in step 220B, the customer 36 pays for the AI generated artwork 242 using either of the options presented.

With reference to FIG. 15F, if the option to pay by QR code 128 is selected, upon scanning the QR code by a customer mobile computing device, such as a customer's cell phone 40 (see FIG. 1), the customer cell phone 40 communicates with the server 294, which makes the customer cell phone 40 display the payment screen 232 and the steps to follow to make the payment using the customer's cell phone 40.

With reference to FIG. 15G an exemplary print status screen 234, is depicted. In step 222A, the UI 34 creates and displays the print status screen 234 on monitor 16A. While displaying the print status screen 234, the UI 34 prints the AI generated artwork 242 using the printer 26 and, if needed, the pen plotter 28, both of which are located in the photobooth style cabinet 12. In step 222B, the customer picks up the AI generated artwork 242 from a pickup tray 92 in the photobooth style cabinet 12.

### Artwork Protection Option

When a customer has an artwork produced or provided by the system for the remote creation and delivery of digital portraits 10, an option may be provided to have the artwork authenticated. An artwork may be prepared for authentication at the time of printing, as for example, in steps 160B of the option to purchase autographed images of celebrities or in step 192B of the option to purchase artwork. NFC tags containing authentication information may also be added to prints of artwork purchased or produced by the system 10. Encrypted images created by the system 10 may also be stored on a remote server.

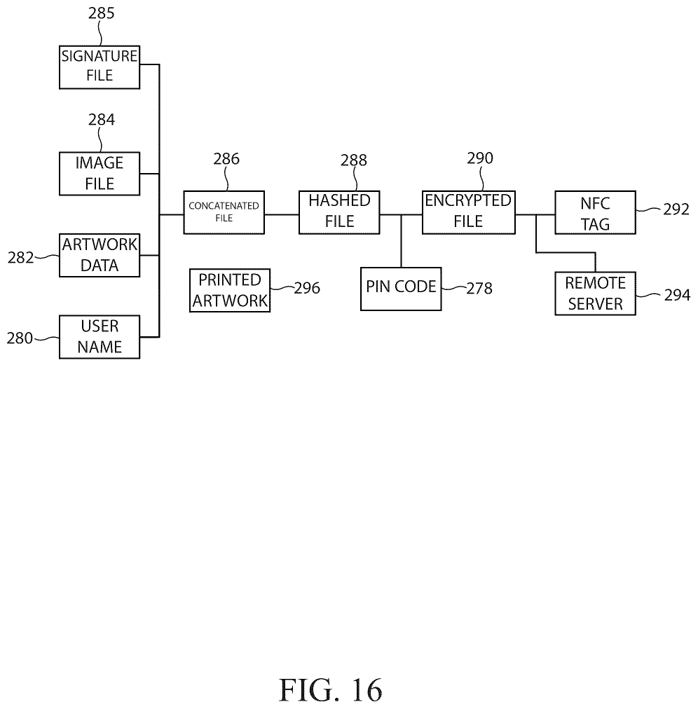

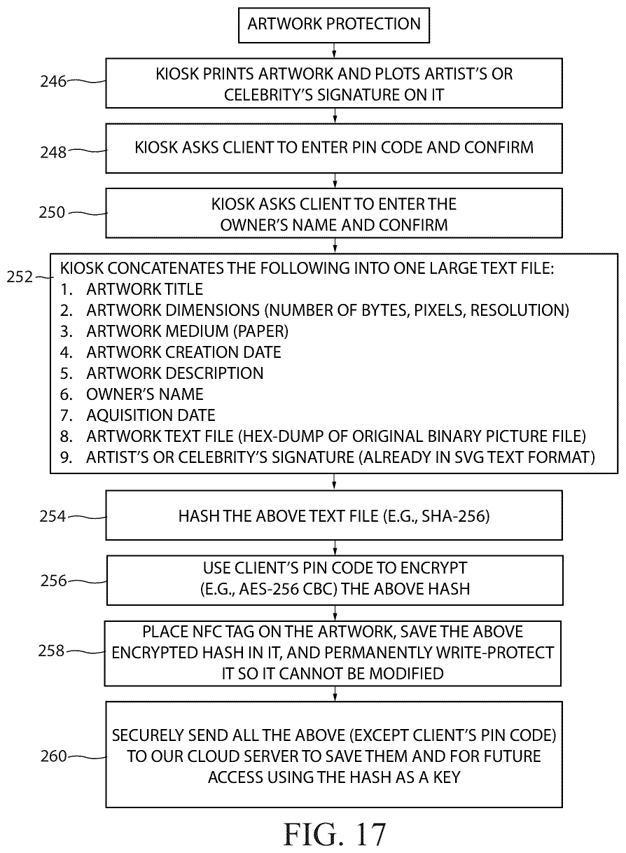

With reference to FIGS. 16 and 17, an exemplary artwork protection method suitable for use with the system and method for the creation and delivery of digital portraits 10, as part of or following either steps 160B or 192B, is as follows:

In step 246, the system 10 prints an artwork 296 and plots an artist's or celebrity's signature associated with the artwork on the print. In step 248, the system 10 prompts the user 36 to enter a PIN code 278 and confirm the code. In step 250, the system prompts user 36 to enter a user name (owner name) 280 and confirm. In step 252, the system concatenates the artwork data 282 with the user name 280 into a single, concatenated file 286. The artwork data 282 may include the artwork's title, dimensions (number of bytes, pixels, resolution), medium, creation date, description, acquisition date, the artwork image 284 converted to text format, artist's or celebrity's signature file 285, among other information. In step 254, the single, concatenated file 286 is hashed to create a hashed file 288. Suitable hashing algorithms such as SHA-256 are known in the art. In step 256, the user's pin code 278 is used to encrypt the hashed file 288 to create an encrypted file 290. In step 258, the encrypted file 290 is written to an NFC tag 292, which is write-protected, then affixed to the printed artwork 296. In step 260, the hash 288 and the encrypted file 290 are securely sent and stored on a remote server 294. On the remote server 294, the hash 288 will be used as the access key to the encrypted file 290.

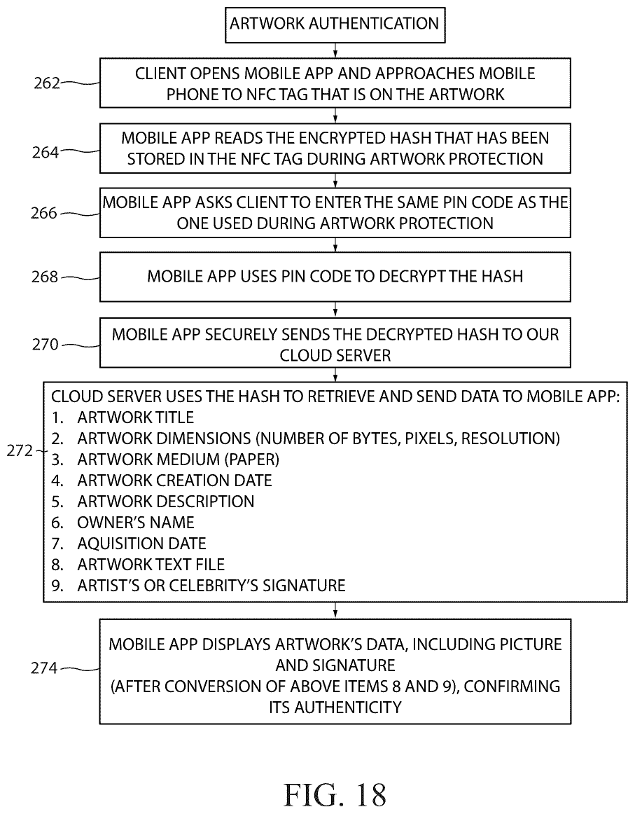

With reference to FIG. 18, an exemplary authentication procedure suitable for use with the system and method for the creation and delivery of digital portraits 10, is a follows:

In step 262, the user 36 brings a customer cell phone 40 running an authentication mobile application 41 near the NFC tag 292 affixed to the printed artwork 296. In step 264, the authentication mobile application 41 reads the encrypted hash 290 that has been stored in the NFC tag 292. In step 266, the authentication mobile application 41 prompts the user 36 to enter the pin code 278. In step 268, the authentication mobile application 41 uses the pin 278 to decrypt the hashed file 290 and creates the clear hash 288 locally. In step 270, the authentication mobile application securely sends the clear hash 288 to the remote server 294, and, in step 272, retrieves the artwork concatenated file 286. In step 274, artwork data 282, image file 284 and artist's or celebrity's signature file 285 are extracted from the concatenated file 286 and are displayed to the user 36, thereby confirming the authenticity of the printed artwork 296.

In accordance with the description herein, suitable computing devices include, by way of non-limiting examples, server computers, desktop computers, laptop computers, notebook computers, netbook computers, smartphones and tablet computers, among others. Those of skill in the art will also recognize that select televisions and video game consoles with computer network connectivity are suitable for use in the system described herein.

As used herein, a software application is a computer program that includes a sequence of instructions, executable on digital processing devices, written to perform a specified task. Computer readable instructions may be implemented as program modules, such as functions, objects, application programming interfaces, data structures, and the like, that perform particular tasks or implement particular data types. In light of the disclosure provided herein, those of skill in the art will recognize that a computer program may be written in various versions of various languages.

As used herein an operating system is, for example, software, including programs and data, which manage a computing device's hardware and provide services for the execution of software applications. Those of skill in the art will recognize that suitable server operating systems include, by way of nonlimiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. Those of skill in the art will also recognize that suitable mobile smart phone operating systems include, by way of non-limiting examples, Nokia® Symbian® OS, Apple® iOS®, Research In Motion® BlackBerry OS®, Google Android®, Microsoft® Windows Phone® OS, Microsoft® Windows Mobile® OS, Linux®, and Palm® WebOS®.

As referred to herein, a memory device is one or more physical devices used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

What is claimed is:

1. A system for the remote creation and delivery of digital portraits, comprising:
a local computing device and a remote computing device interconnected by a network;
wherein the local computing device is connected to input devices including a microphone, speakers, camera and a display device;
wherein the remote computing device is connected to input devices including a camera, a microphone, speakers and a display device;
wherein a user interface application (“UI”) is stored in memory on the local and remote computing devices;
wherein a database of remotely located artists is stored on the local computing device;
wherein the remote computing device includes a digital painting application;
wherein the local and remote computing devices are configured to allow audio-visual communication with each other;
wherein the UI on the local computing device is configured to allow a user to select a remotely located artist from the database of remotely located artists;
wherein the UI on the local computing device is configured to allow a user to place a video call to the selected remotely located artist; and
wherein the UI on the remote computing device is configured to allow the selected remotely located artist to access the digital painting application on the remote computing device to paint a digital image of the user of the local computing device.

2. The system for the remote creation and delivery of digital portraits of claim 1, further including a printer connected to the local computer for printing the digital image.

3. The system for the remote creation and delivery of digital portraits of claim 2, further including a plotter.

4. The system for the remote creation and delivery of digital portraits of claim 3, wherein the plotter is a pen plotter.

5. The system for the remote creation and delivery of digital portraits of claim 1, wherein the camera of the local computing device includes pan, tilt, zoom, and automatic face-tracking capabilities.

6. The system for the remote creation and delivery of digital portraits of claim 1, wherein the UI on the local and remote computing devices is configured to allow a user of the remote computing device to control the camera of the local computing device.

7. The system for the remote creation and delivery of digital portraits of claim 1, wherein the display device of the local computing device is a touch screen monitor.

8. The system for the remote creation and delivery of digital portraits of claim 1, wherein the input devices of the local computing device further includes a card payment unit.

9. The system for the remote creation and delivery of digital portraits of claim 1, wherein the local computing device and the connected input, output and display devices are disposed within a cabinet.

10. The system for the remote creation and delivery of digital portraits of claim 9, wherein the cabinet is configured as a photo booth.

11. The system for the remote creation and delivery of digital portraits of claim 10, wherein the cabinet is configured to include a mirror which reflects an image of a user.

12. A method for the remote creation and delivery of digital portraits, comprising the steps of:
providing a local computing device equipped with a camera, monitor, microphone, speaker, and, a database of remotely located artists;
providing a remote computing device equipped with a camera, monitor, microphone, speaker, and a digital painting application;
providing a network interconnecting the local computing device and the remote computing device;
providing a user interface (“UI”) stored in memory on the local computing device and the remote computing device;
generating by the UI a search screen and selection display screen for searching the database of remotely located artists;
searching by a user of the local computing device, the database of remotely located artists;
selecting by the user of the local computing device, a remotely located artist accessible on the remote computing device;
generating by the UI, a video call display screen;
placing, by the user of the local computing device, a video-call to the selected remotely located artist;
generating by the UI, a workspace sharing screen;
sharing, by the remotely located artist, the workspace on the remote computing device with the local computing device;
generating by the UI, a painting progress display screen;
painting, by the remotely located artist, a digital image of the user of the local computing device;
generating by the UI, a digital image transfer screen;
sending by the remotely located artist the painted digital image to the user of the local computing device;
generating by the UI, a payment screen;
selecting, by the user of the local computing device, a method of payment for the painted digital image; and
delivering the painted digital image.

13. The method for the remote creation and delivery of digital portraits of claim 12, wherein the step of delivering the painted digital image comprises creating by the UI, a printing status screen, and, printing using a printer connected to the local computing device, the painted digital image.

14. The method for the remote creation and delivery of digital portraits of claim 13, further comprising the step of providing a plotter connected to the local computing device.

15. The method for the remote creation and delivery of digital portraits of claim 14, further comprising the step of using the plotter to add indicia to the printed, painted digital image.

16. The method for the remote creation and delivery of digital portraits of claim 12, further comprising the step of providing the camera of the local computing device with pan, tilt, zoom, and automatic face-tracking capabilities.

17. The method for the remote creation and delivery of digital portraits of claim 16, further comprising the step of providing the remote computing device with the ability to control the camera of the local computing device.

18. A method for the remote creation and delivery of digital images, comprising the steps of:
providing a local computing device equipped with a camera, monitor, microphone, speaker and, a database of digital images;
providing a user interface (“UI”) stored in memory on the local computing device;
generating by the UI a search screen and selection display screen for searching the database of digital images;
searching by a user of the local computing device, the database of digital images;
selecting by the user of the local computing device, a digital image;
generating by the UI, a painted version of the digital image;
generating by the UI, a payment screen;
selecting, by the user of the local computing device, a method of payment for the painted version of the digital image; and
delivering the painted version of the digital image.

19. The method for the remote creation and delivery of digital portraits of claim 18, wherein the step of delivering the painted digital image comprises creating by the UI, a printing status screen; and printing using a printer connected to the local computing device, the painted digital image.
